(19) United States
(12) Patent Application Publication
(10) Pub. No.: US 2013/0300099 A1
(43) Pub. Date: Nov. 14, 2013

(54) Oversize Paper Sheet

(71) Applicant: Andrew STUHL, Lake Worth, FL (US)

(72) Inventor: Andrew STUHL, Lake Worth, FL (US)

(73) Assignee: TRALY, INC.

(21) Appl. No.: 13/470,927

(22) Filed: May 14, 2012

(51) Int. Cl. B42D 19/00

(52) U.S. Cl. 281/5

(57) ABSTRACT

An oversize sheet of paper has a rectangular main portion, a first edge portion or strip and a second edge portion or strip. The main portion is of standard dimensions and has two parallel long edges and two parallel short edges. The first and second edge portions are contiguous with the main portion along respective edges thereof. The edge portions are separable from the main portion along respective weakened lines. The first edge portion and the second edge portion are each printed on at least one major surface with alphanumeric material germane to a particular topic or academic subject.

### BACKGROUND OF THE INVENTION

The present invention is directed to a sheet of paper and more particularly to an oversize sheet of paper.

In testing students particularly in mathematics and sciences the main interest is in gauging the students' skills in applying principles to diverse sets of facts. A frequent problem is remembering the principles in order to apply them to the given fact patterns. One solution has been to give so-called “open book” tests where the students are permitted to consult their textbooks during the examination.

It is considered that open book tests are unfair in that some students have notes written directly into their textbooks whereas others use clean textbooks to maximize resale value. Another problem is that students frequently waste their precious test time in leafing through their textbooks to find the applicable formulas or principles.

### OBJECTS OF THE INVENTION

It is an object of the present invention to provide a sheet of paper that is useful in academic testing.

It is another object of the present invention to provide such a sheet of paper that obviates or alleviates the above-described problems in testing students.

A further object of the present invention is to provide a related method of testing students.

These and other objects of the invention will be apparent from the drawings and descriptions herein. Although every object of the invention is attained in at least one embodiment of the invention, there is not necessarily any embodiment which attains all of the objects of the invention.

### SUMMARY OF THE INVENTION

An oversize sheet of paper comprises, in accordance with the present invention, a rectangular main portion, a first edge portion or strip and a second edge portion or strip. The main portion is of standard dimensions and has two parallel long edges and two parallel short edges. The first and second edge portions are contiguous with the main portion along respective edges thereof. The edge portions are separable from the main portion along respective weakened lines. The first edge portion and the second edge portion are each printed on at least one major surface with alphanumeric material germane to a particular topic or academic subject.

An oversize paper sheet in accordance with the invention is useful in heuristic or testing environments where the printed subject matter provides rules, formulas, scientific laws, mathematical relations, or other subject matter that may be useful to a student in answering questions on a test. The student may keep the separated margin elements, while the main portion is passed in to a teacher for evaluation.

In its broadest conception the present invention contemplates a standard size piece of paper provided along at least one edge with a separably attached paper extension that is provided on at least a front surface with printed (e.g., alphanumeric) material that may be consulted by the user in writing on the main piece of paper. The printed subject matter may contain drawings or graphics in addition to alphanumeric material. For instance, where the subject matter is geometry, the printed subject matter may include various geometric shapes as well as mathematical relations that hold true for the different geometric shapes.

An oversize sheet of paper in accordance with the present invention may be used instead of a textbook in so-called “open book” examinations. The printed materials on the margin strips or edge portions may be tailored to the material being tested. The invention eliminates the possibility that some students may have unfair advantages owing to handwritten notes or inserts in their textbooks. The invention also reduces the time that students might otherwise waste in leafing through textbooks for relevant assistance.

An oversize sheet of paper in accordance with the present invention may be useful in physics and chemistry as well as various mathematical disciplines. Each of these academic fields includes mathematical relations, formulas, and/or geometric structures in addition to principles that are characterizable in words.

At any rate, an oversize sheet of paper in accordance with the present invention may have one, two, three or four margin elements or edge portions for providing a student with heuristic assistance. Typically, these margin or edge portions are rectangular. However, other shapes may be useful. In a preferred embodiment of the invention, there are exactly two margin elements or edge portions, one disposed along a long edge (e.g., the right-hand edge) and the other located along a short edge (e.g., the bottom edge) of the main sheet portion. Preferably, one of the edge portions or margin strips overlaps the other and is contiguous therewith along a third weakened line that is collinear with one of the first weakened line and the second weakened line.

The weakened tear or separation lines may be implemented by linear arrays of perforations. Alternatively, the weakened tear or separation lines may constitute prefolded joints.

In accordance with another feature of the present invention, an edge portion of an oversize sheet of paper incorporates at least one measurement tool that is separable from remaining part of the edge portion. The measurement tool is manipulable by the user and positionable alternately at various locations on the main portion of the sheet of paper. The measurement tool may take the form of a ruler or linear metric. Alternatively, the measurement tool may be an angular metric or protractor.

The alphanumeric material on the edge portion(s) may include such verbal information as definitions and principles. Thus, an oversize sheet of paper pursuant to the present invention may be useful in social sciences such as economics, political science, sociology, and psychology.

An oversize paper sheet comprises, in accordance with the present invention, a rectangular main portion of standard dimensions and at least one edge portion contiguous with the main portion along one of the edges thereof. The edge portion is separable from the main portion along a weakened line and incorporates at least one measurement tool that is separable from remaining parts of the at least one edge portion.

A heuristic or testing method utilizing an oversize paper sheet in accordance with the present invention includes writing or entering, on the main portion of the paper, subject matter related to the alphanumeric material printed on the margin strip(s) or edge portion(s) and based in part on the alphanumeric material. The method also includes separating the portion(s) from the main portion of the paper sheet and transferring or conveying the main portion without the edge portion(s), for instance, to a teacher or proctor in the case of a testing situation or to a ring binder or other fastening mechanism in the case that the heuristic method is carried out in homework preparation.

The separating of the edge portion(s) from the main portion of the oversize paper sheet typically includes tearing the oversize paper sheet along the weakened line(s).

Where at least one edge portion incorporates a measurement tool, the method may comprise separating the measurement tool from the main body and from other parts of the edge portion and using the separated measurement tool to make measurements on the main portion.

The separating of the edge portion(s) from the main portion may occur before or after writing or entering material on the main portion of the oversize paper sheet.

### BRIEF DESCRIPTION OF THE DRAWING

FIG. 1 is a schematic top plan view of an oversize sheet of paper in accordance with the present invention, with alphanumeric printing omitted.

FIG. 2 is a schematic top plan view of another configuration of an oversize sheet of paper in accordance with the present invention, on a smaller scale and with alphanumeric printing omitted.

FIG. 3 is a schematic top plan view of a further configuration of an oversize sheet of paper in accordance with the present invention, with alphanumeric printing omitted.

FIG. 4 a top plan view, on a larger scale, of an oversize sheet of paper, showing printed material on edge portions of the sheet in accordance with the present invention.

### DETAILED DESCRIPTION

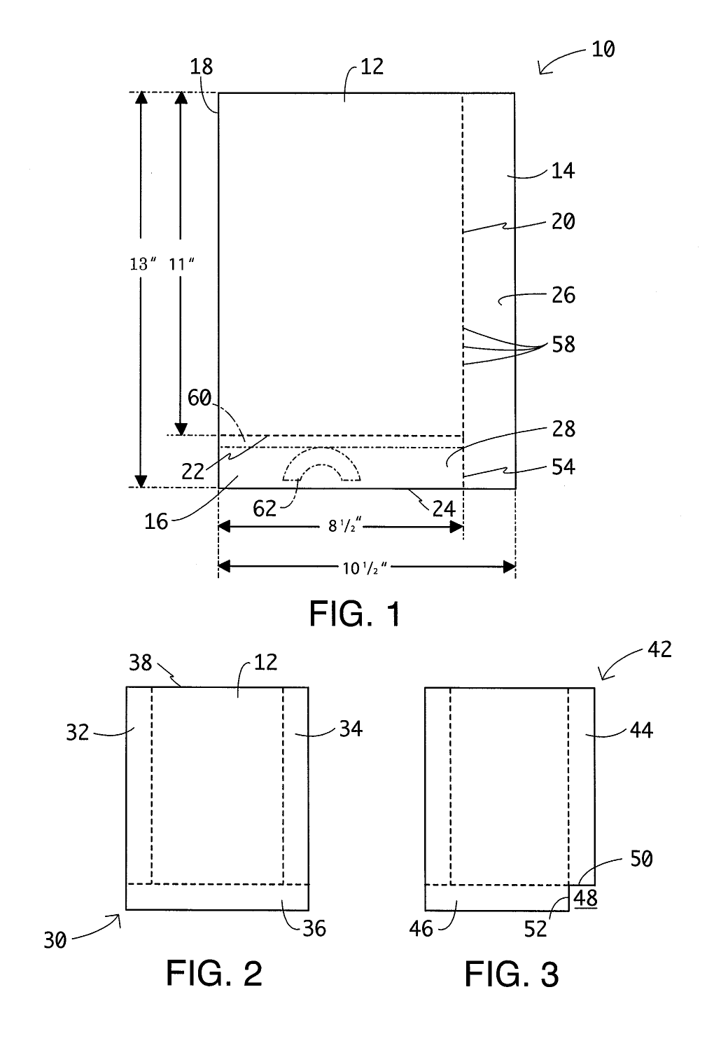

As depicted in FIG. 1, an oversize sheet of paper 10 includes a rectangular main portion 12, a first edge portion or strip 14 and a second edge portion or strip 16. Main sheet portion 12 is of standard dimensions (e.g., 8¼ by 11) and has two parallel long edges 18, 20 and two parallel short edges 22, 24. First and second edge portions 14 and 16 are contiguous with main portion 12 along respective edges 20 and 24 thereof. Edge portions 14 and 16 are separable from main portion 12 along respective weakened lines (not separately designated) coinciding with edges 20 and 24. First edge portion 14 and second edge portion 16 are each printed on at least one major surface 26, 28 (typically, the top surface) with alphanumeric material germane to a particular topic or academic subject.

Oversize paper sheet 10 is useful in heuristic or testing environments where the printed subject matter provides rules, formulas, scientific laws, mathematical relations, or other subject matter that may be useful to a student in answering questions on a test. The student may keep the separated margin elements after the test, while the main portion, containing the student's answers to test questions, is passed in to a teacher for evaluation.

Main sheet portion 12 is optionally provided with three holes 29 punched out along left edge 18 so that students may place the main portion, after separation from edge portions or margin extension strips 14 and 16, in a student three-ring binder or other fastening mechanism. Binder holes 29 may be provided in the main portion of any oversize sheet of paper as described herein. Thus, the present invention facilitates the preparation and storage of homework as well as examinations.

Various modifications of the paper sheet format of FIG. 1 are possible. As depicted in FIG. 2, an oversize sheet of paper 30 may have three margin elements or edge portions 32, 34, and 36 for providing a student with heuristic assistance. These margin or edge portions 32, 34, 36 are rectangular. However, other shapes such as semicircular or triangular may be useful. Of course, another edge portion (not shown) may be added along an upper edge 38 of a main sheet portion 40.

The paper sheet format of FIG. 2 may be modified to position edge strips 32, 34, 36 along any combination of edges of main sheet portion 40. Similarly, the paper sheet format of FIG. 1 may be modified to position the two edge strips 14 and 16 along any combination of edges 18, 20, 22, 24 of main sheet portion 12. For instance, edge strips 14, 16 may both be longitudinal (disposed along the left and right edges 18, 20) or transverse (disposed along the upper and lower edges 22, 24).

FIG. 3 shows another modification 42 of oversize paper sheet 10, wherein a pair of border strips or edge portions 44 and 46 are adjacent but not overlapping. Instead, there is a rectangular cutout 48 defined by edges 50 and 52 of border strips or edge portions 44 and 46.

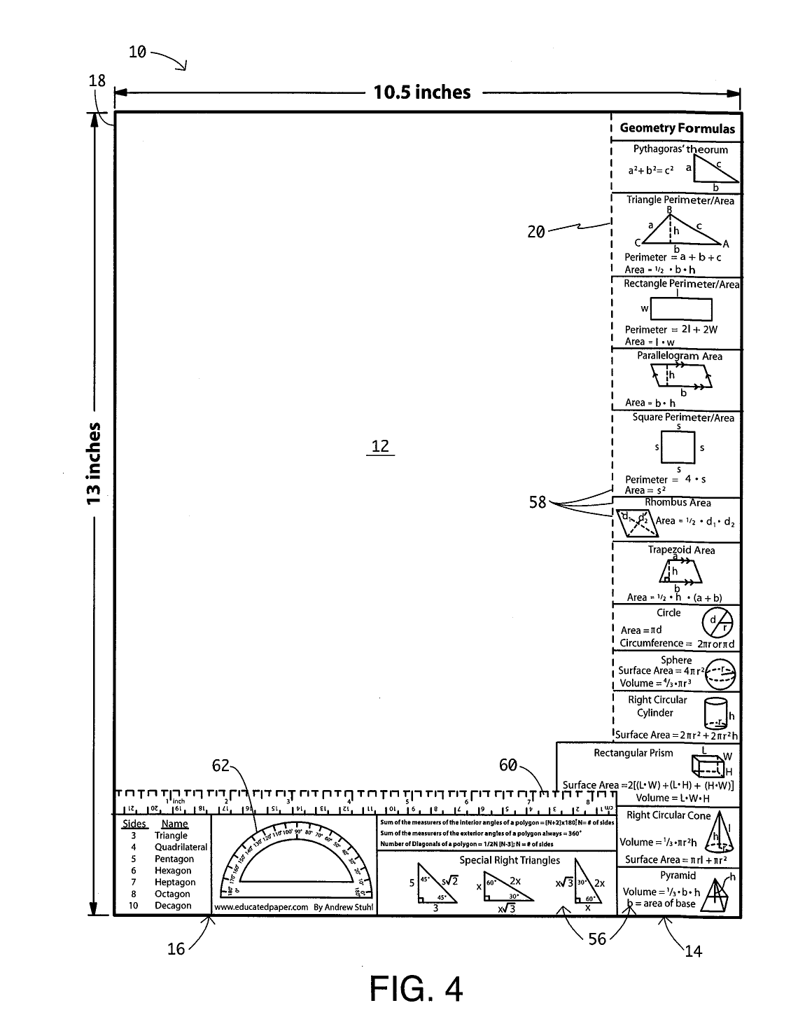

FIG. 4 illustrates oversize paper sheet 10 in greater detail. Margin strip or edge portion 14 is disposed along the right-side or right-hand long edge 20 and margin strip or edge portion 16 is disposed along the lower or bottom edge 24 of the main sheet portion 12. Preferably, one of the edge portions or margin strips 14, 16 (namely, margin strip 14) overlaps the other (16) and is contiguous therewith along a third weakened line 54 that is collinear with the first weakened line 20. Major surfaces 26 and 28 of margin strips or edge portions 14 and 16 are with provided with printed material 56 germane to the academic subject of geometry. More particularly, the printed material 56 includes graphics of various geometric shapes and various mathematical relationships pertinent to the respective geometric shapes.

Tear or separation lines 20, 24, 54 may be implemented by linear arrays of perforations 58. Alternatively, the weakened tear or separation lines 20, 24, 54 may constitute prefolded joints. Another alternative is implemented by razor cuts extending part way through the paper.

As depicted in FIGS. 1 and 4, edge portion 16 of oversize paper sheet 10 incorporates two measurement tools, namely, a rule or metric 60 and a protractor 62, which are separable from remaining parts of edge portion 16. These measurement tools 60 and 62 are manipulable by the user and positionable alternately at various locations on main sheet portion 12.

Printed material 56 on edge portions 14 and 16 may include such verbal information as definitions and principles. Thus, an oversize sheet of paper pursuant to the present invention may be useful in academic testing in arts such as literature and in social sciences such as economics, political science, sociology, and psychology.

An oversize paper sheet pursuant to principles described herein may comprise one or more margin elements that are measurement tools without additional alphanumeric material. However, it is contemplated that the margin strips or edge elements contain printed subject matter in addition to markings and numerals provided on the measurement tool.

Use of an oversize paper sheet 10, 30, 42 typically includes writing or entering, on main portion 12, 40 of the paper, subject matter related to the alphanumeric material printed on the margin strips or edge portions 14, 16, 32, 34, 36 and based in part on the printed material 56. The method also includes separating the margin strips or edge portions 14, 16, 32, 34, 36 from the main portion 12, 40 of the paper sheet 10, 30, 42 and transferring or conveying the main portion 12, 40 without the edge portions 14, 16, 32, 34, 36, for instance, to a teacher or proctor. The separating of the edge portions 14, 16, 32, 34, 36 from the main portion 12, 40 of the oversize paper sheet 10, 30, 42 typically includes tearing the oversize paper sheet along the weakened lines 20, 24, 54. Where at least one edge portion, e.g., 16, incorporates a measurement tool 60, 62, the method may comprise separating the measurement tool 60, 62 from the main body 12, 40 and from other parts of the edge portion 16 and using the separated measurement tool 60, 62 to make measurements on the main portion 12, 40. The separating of the edge portions 14, 16, 32, 34, 36 from the main portion 12, 40 may occur before or after writing or entering material on the main portion 12, 40 of the oversize paper sheet 10, 30, 42.

Although the invention has been described in terms of particular embodiments and applications, one of ordinary skill in the art, in light of this teaching, can generate additional embodiments and modifications without departing from the spirit of or exceeding the scope of the claimed invention. For instance, at least margin portion 16 may be provided along a rear surface with an adhesive layer and a protective removable cover sheet for enabling the attachment of ruler 60 and protractor 62 to a more rigid substrate such as cardboard or a transparent plastic sheet, thereby facilitating use of the ruler and protractor as straight edge drafting tools.

It is also possible to provide the margin strips or edge portions of an oversize sheet of paper as described herein with other kinds of tools, such as templates for drawing geometric figures. In a more advanced embodiment, tools made of materials other than paper may be removably attached to the edge strips. For example, in the case of geometry, such tools may include a compass or pins and string for drawing circles and ellipses. Accordingly, it is to be understood that the drawings and descriptions herein are proffered by way of example to facilitate comprehension of the invention and should not be construed to limit the scope thereof.

What is claimed is:

1. An oversize paper sheet comprising:
a rectangular main portion of standard dimensions, said main portion having two parallel long edges and two parallel short edges;
a first edge portion contiguous with said main portion along one of said long edges and said short edges; and
a second edge portion contiguous with said main portion along another of said long edges and said short edges,
said first edge portion being separable from said main portion along a first weakened line,
said second edge portion being separable from said main portion along a second weakened line,
said first edge portion and said second edge portion each printed on at least one major surface with alphanumeric material germane to a particular topic or academic subject.

2. The oversize paper sheet of claim 1 wherein said first edge portion is contiguous with said main portion along one of said long edges and said second edge portion is contiguous with said main portion along another of said short edges.

3. The oversize paper sheet of claim 2 wherein one of said first edge portion and said second edge portion overlaps the other of said first edge portion and said second edge portion and is contiguous therewith along a third weakened line that is collinear with one of said first weakened line and said second weakened line.

4. The oversize paper sheet of claim 3 wherein said first weakened line and said second weakened line are linear arrays of perforations.

5. The oversize paper sheet of claim 4 wherein at least one of said first edge portion and said second edge portion incorporates at least one measurement tool that is separable from remaining parts of said at least one of said first edge portion and said second edge portion.

6. The oversize paper sheet of claim 5 wherein said at least one measurement tool is a ruler.

7. The oversize paper sheet of claim 5 wherein said at least one measurement tool is a protractor.

8. The oversize paper sheet of claim 1 wherein said first weakened line and said second weakened line are linear arrays of perforations.

9. The oversize paper sheet of claim 1 wherein at least one of said first edge portion and said second edge portion incorporates at least one measurement tool that is separable from remaining parts of said at least one of said first edge portion and said second edge portion.

10. The oversize paper sheet of claim 9 wherein said at least one measurement tool is taken from the group consisting of a ruler and a protractor.

11. The oversize paper sheet of claim 1 wherein said alphanumeric material includes mathematical or scientific formulas.

12. The oversize paper sheet of claim 1 wherein said alphanumeric material includes definitions.

13. An oversize paper sheet comprising:
a rectangular main portion of standard dimensions, said main portion having two parallel long edges and two parallel short edges; and
at least one edge portion contiguous with said main portion along one of said long edges and said short edges,
said at least one edge portion being separable from said main portion along a weakened line,
said at least one edge portion incorporating at least one measurement tool that is separable from remaining parts of said at least one edge portion.

14. The oversize paper sheet of claim 13 wherein said measurement tool is taken from the group consisting of a ruler and a protractor.

15. A heuristic or testing method comprising:
providing an oversize paper sheet having a rectangular main portion of standard dimensions and with two parallel long edges and two parallel short edges, a first edge portion contiguous with said main portion along one of said long edges, and a second edge portion contiguous with said main portion along one of said short edges, said first edge portion and said second edge portion each printed on at least one major surface with alphanumeric material germane to a particular topic or academic subject;
writing or entering on said main portion subject matter related to said alphanumeric material and based in part on said alphanumeric material;
separating said first edge portion and said second edge portion from said main portion; and
transferring or conveying said main portion without said first edge portion and said second edge portion.

16. The method of claim 15 wherein said first edge portion is contiguous with said main portion along a first weakened line and said second edge portion is separable from said main portion along a second weakened line, the separating of said first edge portion and said second edge portion from said main portion including tearing said oversize paper sheet along said first weakened line and said second weakened line.

17. The method of claim 15 wherein at least one of said first edge portion and said second edge portion incorporates at least one measurement tool, further comprising separating said at least one measurement tool from said main body and from other parts of said at least one of said first edge portion and said second edge portion, also comprising using the separated measurement tool to make measurements on said main portion.

18. The method of claim 15 wherein the separating of said first edge portion and said second edge portion from said main portion occurs at least in part after the writing or entering of said subject matter on said main portion.
